(19) United States
(12) Patent Application Publication
(10) Pub. No.: US 2018/0188104 A1
(43) Pub. Date: Jul. 5, 2018

(54) SIGNAL DETECTION DEVICE, SIGNAL DETECTION METHOD, AND RECORDING MEDIUM

(71) Applicant: NEC Corporation, Minato-ku, Tokyo (JP)

(72) Inventors: Yumi Arai, Tokyo (JP); Yuzo Senda, Tokyo (JP)

(73) Assignee: NEC Corporation, Minato-ku, Tokyo (JP)

(21) Appl. No.: 15/736,380

(22) PCT Filed: Jun. 20, 2016
(86) PCT No.: PCT/JP2016/002939

§ 371 Date: Dec. 14, 2017

(30) Foreign Application Priority Data
Jun. 26, 2015 (JP) 2015-128481

(51) Int. Cl. G01H 3/00; G01S 3/808

(52) U.S. Cl. CPC G01H 3/00; G01S 3/808

(57) ABSTRACT

Even a small sound for which a change in a histogram is small can be accurately detected. A signal detection device includes signal input means for inputting signals acquired by a plurality of sensors, cross-correlation function calculation means for calculating cross-correlation functions for each predetermined number of samples, based on the signals, and background noise model derivation means for deriving a background noise model, based on the cross-correlation functions; and detection means for detecting a change in the signals, based on comparison of values of the cross-correlation functions with the background noise model.

### TECHNICAL FIELD

The present invention relates to a signal detection device, a signal detection method, and a recording medium.

### BACKGROUND ART

In the above-described technical field, PTL 1 discloses a technique of determining whether an abnormality has occurred in a sound field, based on input signals of a microphone array, as one example of a technique for detecting a change in a sound field, in order to acoustically recognizing an abnormal operation of equipment. Specifically, in PTL 1, at each time, sound source directions are estimated and then a temporal change in a histogram over a sound source directions is calculated. When a sound source direction for which a change is large is detected, it is determined that an abnormality in the sound field has occurred for this sound source direction.

### CITATION LIST

### Patent Literature

[PTL1] Japanese Patent No. 5452158

### SUMMARY OF INVENTION

### Technical Problem

However, in the technique described in the above-described literature, small sound leads to a small change in the histogram, and thus cannot be accurately detected.

An object of the present invention is to provide a technique that solves the above-described problem.

### Solution to Problem

A signal detection device according to an exemplary aspect of the present invention includes: signal input means for inputting signals acquired by a plurality of sensors; cross-correlation function calculation means for calculating cross-correlation functions for each predetermined number of samples, based on the signals; background noise model derivation means for deriving a background noise model, based on the cross-correlation functions; and detection means for detecting a change in the signals, based on comparison of values of the cross-correlation functions with the background noise model.

A signal detection method according to an exemplary aspect of the present invention includes: inputting signals acquired by a plurality of sensors; calculating cross-correlation functions for each predetermined number of samples, based on the signals; deriving a background noise model, based on the cross-correlation functions; and detecting a change in the signals, based on comparison of values of the cross-correlation functions with the background noise model.

A computer readable storage medium according to an exemplary aspect of the present invention records thereon a signal detection program causing a computer to execute: a signal input step for inputting signals acquired by a plurality of sensors; a cross-correlation function calculation step for calculating cross-correlation functions for each predetermined number of samples, based on the signals; a background noise model derivation step for deriving a background noise model, based on the cross-correlation functions; and a detection step for detecting a change in the signals, based on comparison of values of the cross-correlation functions with the background noise model.

### Advantageous Effects of Invention

According to the present invention, even small sound for which a change in a histogram is small can be accurately detected.

### BRIEF DESCRIPTION OF DRAWINGS

FIG. 1 is a block diagram illustrating a configuration of a signal detection device according to a first example embodiment of the present invention.

FIG. 2 is a diagram illustrating a summary of operation of a signal detection device according to a second example embodiment of the present invention.

FIG. 3 is a block diagram illustrating a configuration of the signal detection device according to the second example embodiment of the present invention.

FIG. 4A is a diagram illustrating a configuration of a frame table included in the signal detection device according to the second example embodiment of the present invention.

FIG. 4B is a diagram illustrating a configuration of a sensor performance table included in the signal detection device according to the second example embodiment of the present invention.

FIG. 5 is a block diagram illustrating a hardware configuration of the signal detection device according to the second example embodiment of the present invention.

FIG. 6 is a flowchart illustrating processing procedure of the signal detection device according to the second example embodiment of the present invention.

FIG. 7 is a block diagram illustrating a configuration of a signal detection device according to a third example embodiment of the present invention.

FIG. 8 is a flowchart illustrating processing procedure of the signal detection device according to the third example embodiment of the present invention.

FIG. 9 is a block diagram illustrating a configuration of a signal detection device according to a fourth example embodiment of the present invention.

FIG. 10 is a flowchart illustrating processing procedure of the signal detection device according to the fourth example embodiment of the present invention.

FIG. 11 is a diagram illustrating an advantageous effect in using a Mahalanobis distance in the signal detection device according to the second example embodiment of the present invention.

### DESCRIPTION OF EMBODIMENTS

In the following, example embodiments of the present invention will be described in detail with reference to the drawings. Note that configurations, values, flows of processing, functional elements, and the like described in the following example embodiments are each merely one example, and changes and modifications thereof are freely made, and it is not intended to limit the technical scope of the present invention to the following description. Although the following describes the cases where an audio signal is acquired by using a microphone as a sensor, means for acquiring the audio signal is not limited to this. For example, a signal of a band exceeding an audible range can be acquired by using a vibration sensor or an antenna, as well.

### First Example Embodiment

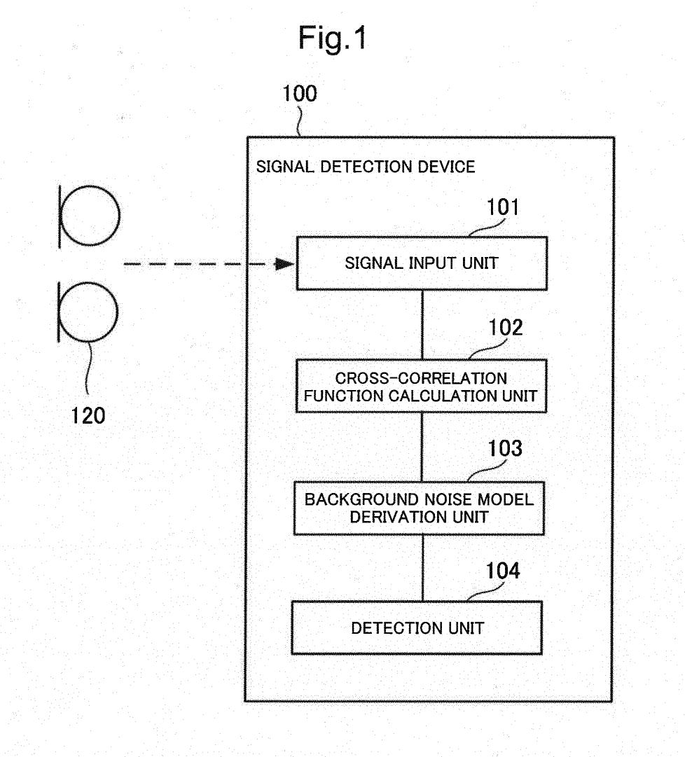

A signal detection device 100 as a first example embodiment of the present invention will be described referring to FIG. 1. The signal detection device 100 is a device that detects a change in signals, based on signals acquired by a plurality of sensors. As illustrated in FIG. 1, the signal detection device 100 includes a signal input unit 101, a cross-correlation function calculation unit 102, a background noise model derivation unit 103, and a detection unit 104.

The signal input unit 101 inputs signals acquired by a plurality of sensors 120. The cross-correlation function calculation unit 102 calculates cross-correlation functions for each predetermined number of samples based on the signals input by the signal input unit 101. The background noise model derivation unit 103 derives a background noise model based on the calculated cross-correlation functions. The detection unit 104 detects a change in signals based on comparison of values of the cross-correlation functions with the background noise model.

According to the present example embodiment, even small sound for which a change in a histogram is small can be accurately detected.

### Second Example Embodiment

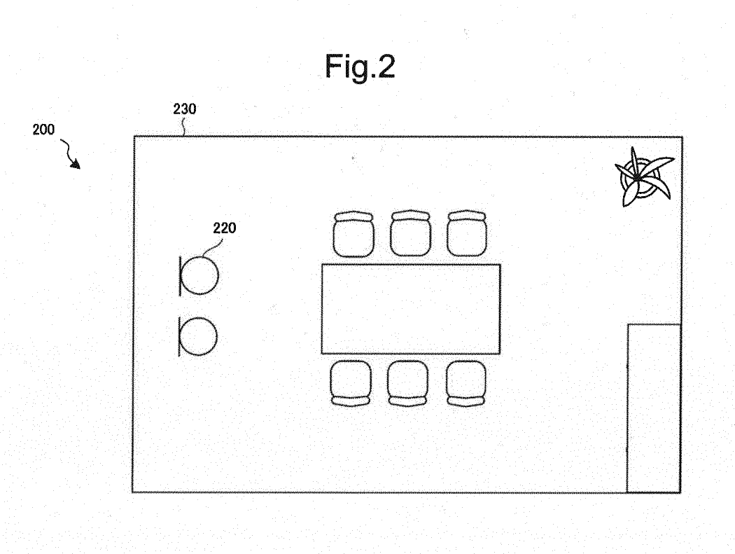

Next, a signal detection device 200 according to a second example embodiment of the present invention will be described referring to FIG. 2 to FIG. 6.

### <Underlying Technique>

First, underlying technique for the present example embodiment is described. As a method for determining whether an abnormality has occurred in a sound field from input signals of a microphone array, for example, an acoustic monitoring system described in the PTL 1, at each time, estimates sound source directions, and then calculates a temporal change in a histogram of volume over sound source directions. When a sound source direction for which a temporal change in the histogram is large is detected, the acoustic monitoring system determines that an abnormality has occurred for the detected sound source direction.

However, in the acoustic monitoring system, since an abnormality in a sound field is detected based on a temporal change in a histogram of volume over sound source directions, it is difficult to detect the change when a temporal change in the histogram of volume for the sound is small such as in the case of small sound.

Further, when volume of an existing sound source changes, the change in volume causes a change in the histogram. This sometimes causes an erroneous detection of an abnormality relating to a sound source other than the existing sound source or a newly appeared sound source.

### <Technique of Present Example Embodiment>

FIG. 2 is a diagram illustrating a summary of operation of a signal detection device 200 according to the present example embodiment. The signal detection device 200 detects a change in sound based on an entire change in cross-correlation functions, instead of detecting a change in sound for each of directions of sound sources. For example, the signal detection device 200 expresses a change in the cross-correlation functions caused by an existing sound source as a background noise model. Then, when there is a change in the cross-correlation functions that does not match with the background noise model, even a small change can be appropriately detected. For example, in an environment such as a room 230 or the like wherein a sound is echoed and a reverberation occurs, with respect to signals of sounds or the like acquired by sensors 220, there is a correlation between a correlation value for an arriving direction of a direct sound and a correlation value for an arriving direction of a reflected sound. When this correlation does not change, i.e., the correlation is maintained, the cross-correlation functions fall within a range of the background noise model so that it can be determined that a change in the cross-correlation functions has not occurred. However, when the correlation is not maintained because one of the correlation values becomes high, it can be determined that a new sound source has appeared, even though the cross-correlation functions respectively fall within a range of change. Accordingly, a change in a small-sound field due to a newly appeared sound source can be accurately detected.

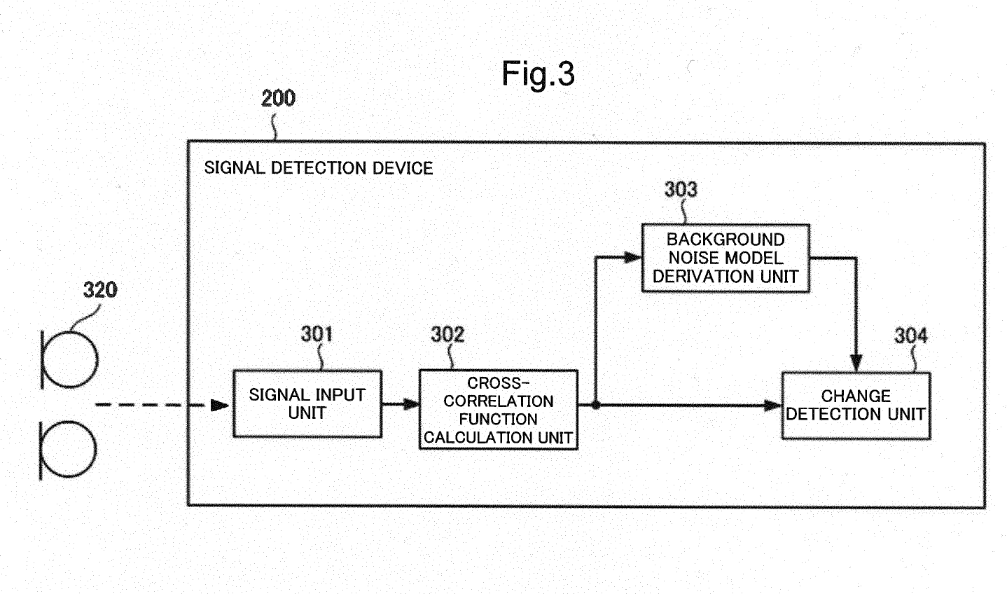

FIG. 3 is a block diagram illustrating a functional configuration of the signal detection device 200 according to the present example embodiment. The signal detection device 200 includes a signal input unit 301, a cross-correlation function calculation unit 302, a background noise model derivation unit 303, and a change detection unit 304. The signal input unit 301 inputs signals x₁(t) and x₂(t) measured in a steady state by using a microphone array 320 including two microphones installed in the room 230, for example. Here, t is a sample number.

The cross-correlation function calculation unit 302 sequentially calculates a cross-correlation function for each fixed number T (referred to as “frame” in the following) of samples, from the signals x₁(t) and x₂(t) from the two microphones input by the signal input unit 301. Assuming that the current frame number is k, a cross-correlation function of the k-th frame can be calculated as a function of a lag sample number τₛ by equation (1).

$$\begin{matrix}[ Equation 1 ] & \\ c ( k , {τ}_{s} ) = \frac{1}{T} {\sum }_{t = {t}_{k}}^{{t}_{k} + T - 1} {x}_{1} ( t ) {x}_{2} ( t + {τ}_{s} ) & ( 1 )\end{matrix}$$

Here, tₖ represents the sample number at the start in the k-th frame. The calculation of the cross-correlation function may be performed after multiplication of a window function, or may be performed equivalently in a frequency region by using the Fast Fourier Transform (FFT). Alternatively, instead of the cross-correlation function of the equation (1), for example, equation (2) in which c(k, τₛ) is transformed into a complex number, or equation (3) which is an absolute value of the equation (2) may be calculated. Using these equations allows to detect a correlation more stably without being affected by minute change in a sound field.

[Equation 2]

c(k,τₛ)→c(k,τₛ)+jH(c(k,τₛ)) (2)

[Equation 3]

c(k,τₛ)→|c(k,τₛ)+jH(c(k,τₛ))| (3)

Here, j represents an imaginary unit, and H(c(k, τₛ)) represents the Hilbert transform of c(k, τₛ).

In the processing hereafter, 1 past frames from the current frame k are used as an evaluation target section [k−l+1, k]. Further, m past frames from the first frame of the evaluation target section are used as a background noise model generation section [k−l−m+1, k−l] for modeling a steady-state noise (a background noise).

In order to suppress influence of an abrupt noise in the background noise model generation section, the number m of frames is set so as to be sufficiently larger compared with a time period during which an abrupt noise occurs. The number 1 of frames may be zero, or may be one or more, but is preferably the number of frames corresponding to a time period during which a change (an acoustic event) to be detected in a sound field occurs, or less than this number.

The background noise model derivation unit 303 derives a background noise model from the cross-correlation functions for the m past frames calculated by the cross-correlation function calculation unit 302. The background noise model derivation unit 303 calculates an average vector μ of equation (4) and a variance-covariance matrix Σ of equation (5) from the cross-correlation functions c(j, τₛ) (k−l−m+1≤j≤k−l) in the background noise model generation section.

$$\begin{matrix}[ Equation 4 ] & \\ μ = {( {μ}_{1} , {μ}_{2} , … , {μ}_{i} , … {μ}_{n} )}^{T} \\ {μ}_{i} = μ ( {τ}_{s , i} ) = \frac{1}{m} {\sum }_{j = k - m + 1}^{k} c ( j , {τ}_{s , i} ) & ( 4 ) \\ [ Equation 5 ] & \\ \sum = {( \begin{matrix}{v}_{11} & … & {v}_{1 n} \\ ⋮ & ⋱ & ⋮ \\ {v}_{n 1} & … & {v}_{nn}\end{matrix} )}^{T} & ( 5 )\end{matrix}$$

Here, y^{T} represents transposition of the column vector y, and τ_{s,i} represents the i-th lag sample number. Further, n is the maximum number (the number of dimensions) of i, and may be set to the number of the lag sample numbers τ_{s,i} corresponding to sound source directions within a range up to ±90 degrees. Alternatively, by also including lag sample numbers corresponding to sound source directions outside ±90 degrees, more correlation between a reflected sound and a direct sound can be taken into account.

Herein, n is two times the number T of samples per frame, at most. Further, ν_{pq} is a covariance between a cross-correlation function c(k, τ_{s,p}) of dimension p and a cross-correlation function c(k, τ_{s,q}) of dimension q.

The change detection unit 304 detects a change in a sound field, based on a distance Dₖ of cross-correlation functions c(k, τₛ) of the current frame k from a background noise model derived by the background noise model derivation unit 303. A typical distance Dₖ is a Mahalanobis distance MDₖ calculated by equation (6).

[Equation 6]

Dₖ=MDₖ=\sqrt{{c(k,τₛ)−μ}^{T}Σ⁻¹{c(k,τₛ)−μ}}

c(k,τₛ)=(c(k,τ_{s,1}),c(k,τ_{s,2}), . . . ,c(k,τ_{s,n}))^{T} (6)

When a distance Dₖ exceeds a threshold value r set in advance, i.e., when a distance Dₖ satisfies equation (7), for all the frames in the evaluation target section [k−l+1, k], it is determined that a change in a sound field has occurred at the frame k−l+1. Alternatively, for example, when the distance Dₖ exceeds the threshold value r during successive frames of a time period equal to or more than a predetermined time length, it may be determined that a change in a sound field has occurred.

[Equation 7]

Dⱼ>r(k−l+1≤j≤k) (7)

When the cross-correlation function follows normal distribution with n dimensions, D² follows χ² distribution with n degrees of freedom. A cumulative distribution function of the χ² distribution is expressed by equation (8).

$$\begin{matrix}[ Equation 8 ] & \\ F ( z ; n ) \frac{\\ γ ( \frac{n}{2} , \frac{z}{2} )}{Γ ( \frac{n}{2} )} z = {D}^{2} & ( 8 )\end{matrix}$$

Herein, γ is an incomplete gamma function, and Γ is a gamma function. By using this property, the threshold value r may be determined depending on a degree to which erroneous detection of a change (an acoustic event) in a sound field is allowable. For example, setting the threshold value r=√z results in that erroneous detection of (1−F(z; n))*100[%] is allowed.

As described above, when a distance (a difference) from a background noise model is large, the signal detection device 200 according to the present example embodiment determines that a change (an acoustic event) in a sound field has occurred in the time frame, and detects such change. Further, a change in correlation between sound source directions can be detected by using a Mahalanobis distance as a distance. This allows to detect even an acoustic event of small volume.

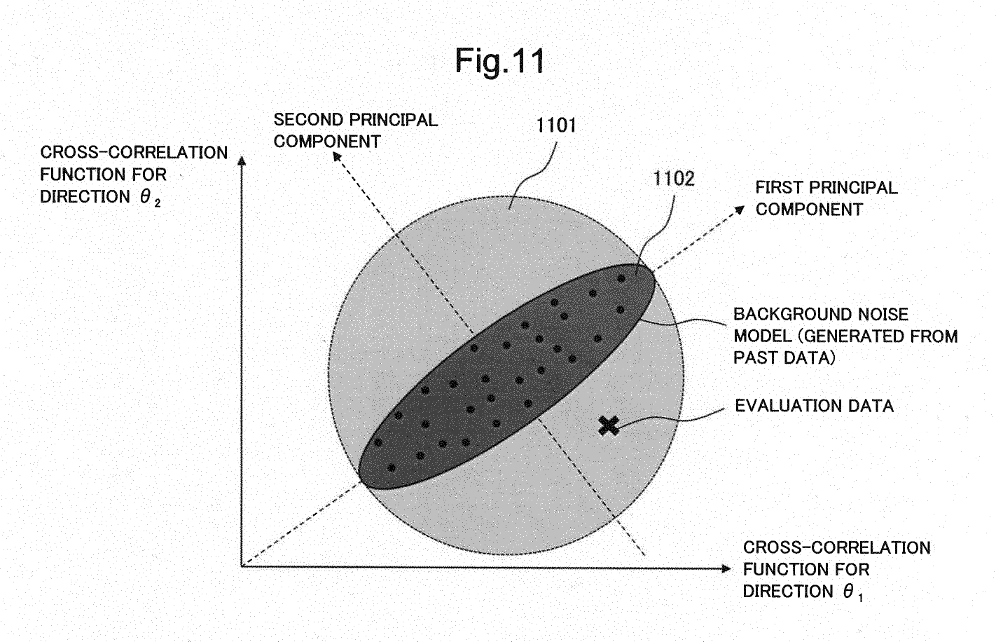

In order to describe an advantageous effect of a Mahalanobis distance in detail, FIG. 11 illustrates a schematic diagram in which cross-correlation functions for respective sound source directions are plotted in a two-dimensional space. A mark x corresponds to values of cross-correlation functions (evaluation data) for a current frame, and black points correspond to values of cross-correlation functions in a background noise model generation section. For example, in the case of using a Euclidean distance, a distance is calculated based on original coordinate axes illustrated by solid arrows, and thus a range 1101 (the light gray range) surrounded by a broken-line circle is regarded as a background noise model. Accordingly, the evaluation data is determined as being in the range of the background noise model, and cannot be detected as an acoustic event. On the other hand, in the case of using a Mahalanobis distance, the coordinate axes are transformed into coordinates that are illustrated by broken-line arrows and that are not correlated to each other, by principal component analysis. A distance is calculated as a sum of squared distances normalized by variances of the respective axes. In other words, a range 1102 (the dark gray range) surrounded by a solid-line ellipse is regarded as the background noise model. Accordingly, the evaluation data can be detected as an acoustic event.

Further, since a change in volume of an existing sound source does not cause a change in the correlation, the change of the existing sound is not erroneously detected. Furthermore, even in an environment, such as an in-room reverberation environment, where there is a correlation between an arriving direction of a direct sound from an acoustic event and an arriving direction of a reflected sound, a change in a sound field can be accurately detected.

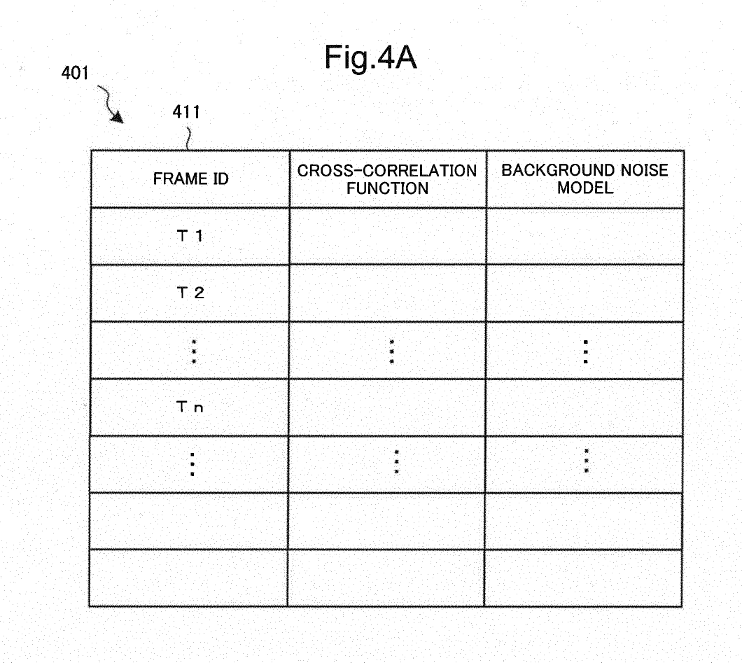

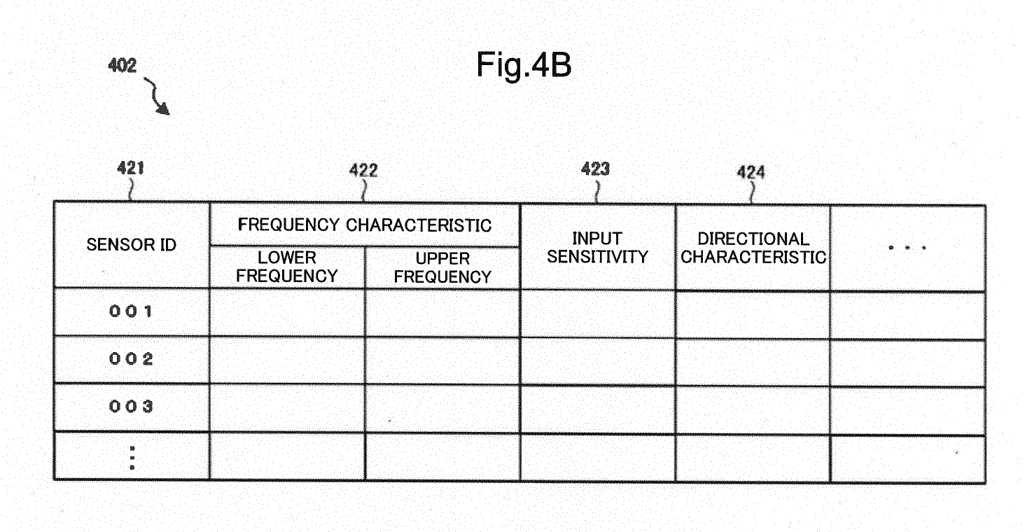

FIG. 4A is a diagram illustrating one example of a configuration of a frame table 401 included in the signal detection device 200 according to the present example embodiment. The frame table 401 stores, in association with a frame identifier (ID) 411, cross-correlation functions and a background noise model for the frame. The signal detection device 200 may calculate cross-correlation functions each time and derive a background noise model. Alternatively, the signal detection device 200 may calculate the cross-correlation functions by using the frame table 401 and derive the background noise model.

FIG. 4B is a diagram illustrating one example of a configuration of a sensor performance table 402 included in the signal detection device 200 according to the present example embodiment. The sensor performance table 402 stores, in association with a sensor ID 421, a frequency characteristic 422, an input sensitivity 423, a directional characteristic 424, and the like. The frequency characteristic 422 includes a lower frequency (kHz) and an upper frequency (kHz). The signal detection device 200 identifies characteristics of signals input from sensors such as microphones, for example, by using the sensor performance table 402, then calculates cross-correlation functions and derives a background noise model based on the characteristics.

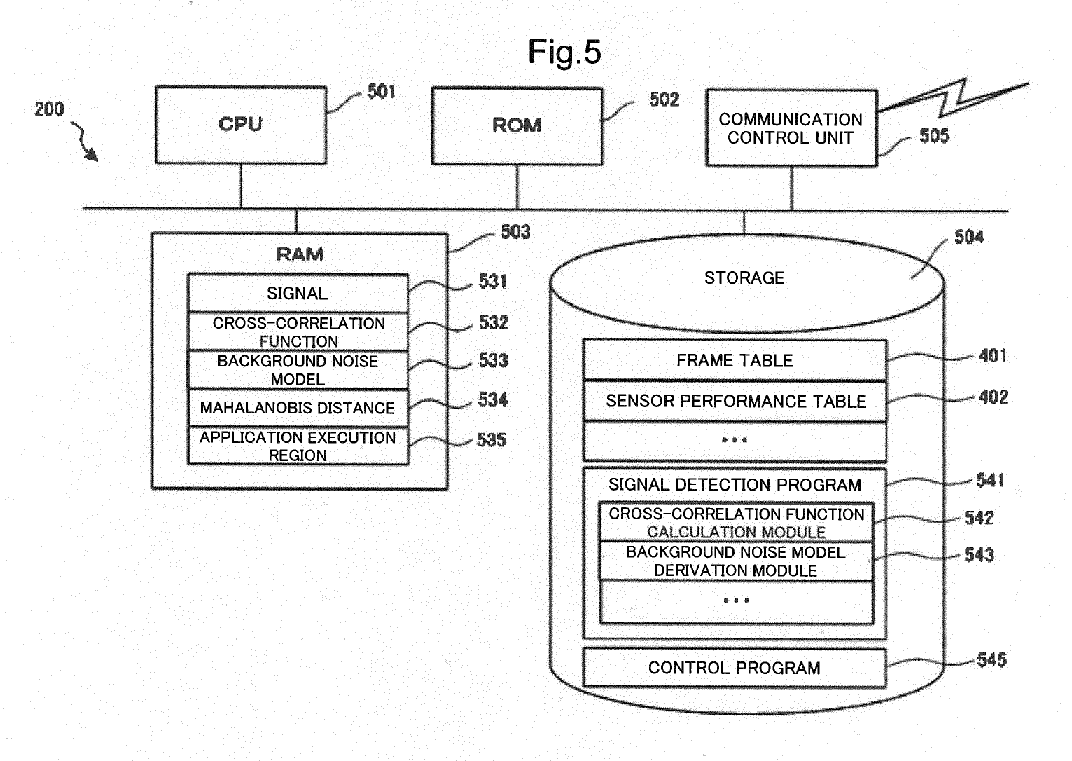

FIG. 5 is a block diagram illustrating a hardware configuration of the signal detection device 200 according to the present example embodiment. The signal detection device 200 includes a central processing unit (CPU) 501, a read-only memory (ROM) 502, a random-access memory (RAM) 503, a storage 504, and a communication control unit 505.

The CPU 501 is a processor for arithmetic processing, and implements each functional constituent unit of the signal detection device 200 by executing a program. Note that the number of the CPUs 501 is not limited to one, and may be plural. The CPU 501 may include a graphics processing unit (GPU) for image processing. The ROM 502 is a read-only memory, and stores a program such as firmware.

The communication control unit 505 communicates with other devices and the like via a network. Further, the communication control unit 505 may include a CPU independent of the CPU 501, and may write or read transmission-reception data in or from the RAM 503.

The RAM 503 is a random-access memory used, as a work area for temporary storage, by the CPU 501. The RAM 503 includes an area that stores data necessary for implementing the present example embodiment. The signal detection device 200 temporarily stores, as such data, signals 531, cross-correlation functions 532, a background noise model 533, and a Mahalanobis distance 534. Further, the RAM 503 includes an application execution region 535 for executing various application modules.

The storage 504 is a storage device that stores a program, a database, and the like necessary for implementing the present example embodiment. The storage 504 stores the frame table 401, the sensor performance table 402, a signal detection program 541, and a control program 545.

The signal detection program 541 includes a cross-correlation function calculation module 542 and a background noise model derivation module 543. These modules 542 and 543 are read out to the application execution region 535 and executed, by the CPU 501. The control program 545 is a program that controls the entire signal detection device 200. Further, a direct memory access controller (DMAC) that transfers data between the RAM 503 and the storage 504 is preferably provided (not illustrated).

Note that programs and data concerning multipurpose functions and other feasible functions of the signal detection device 200 are not illustrated in the RAM 503 and the storage 504 in FIG. 5. Further, since the hardware configuration of the signal detection device 200 described here is merely one example, without limitation to this hardware configuration, various hardware configurations may be adopted.

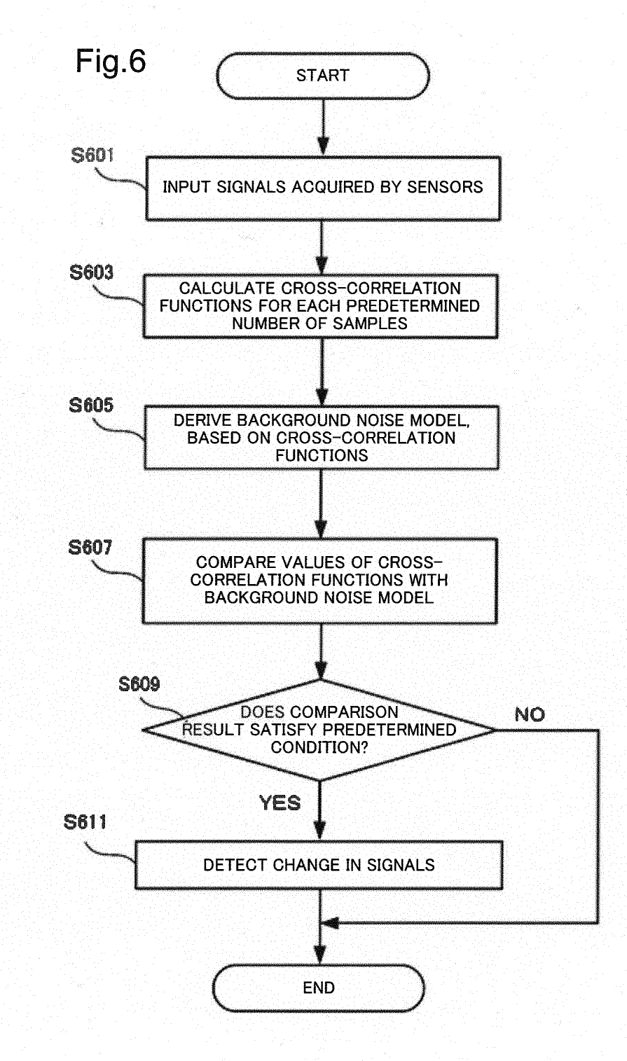

FIG. 6 is a flowchart illustrating processing procedure of the signal detection device 200 according to the present example embodiment. The CPU 501 in FIG. 5 performs processes in the flowchart by using the RAM 503 to implement each functional constituent unit in FIG. 3.

In step S601, the signal detection device 200 inputs signals acquired by the sensors. In step S603, the signal detection device 200 calculates cross-correlation functions for each predetermined number of samples. In step S605, based on the calculated cross-correlation functions, the signal detection device 200 derives a background noise model. In step S607, the signal detection device 200 compares cross-correlation functions with the background noise model. In step S609, the signal detection device determines whether or not the result of the comparison satisfies a predetermined condition. When the result of the comparison satisfies the predetermined condition, in step S611, the signal detection device 200 detects a change in the signals. When the result of the comparison does not satisfy the predetermined condition in the step S609, the signal detection device 200 ends the processing.

According to the present example embodiment, since an entire change in cross-correlation functions are captured instead of detecting a change for each sound source direction, by expressing a change in cross-correlation functions caused by an existing sound source as a background noise model, a change in cross-correlation functions that does not match with the model can be detected even when the change is small. Further, a small change in a sound field due to a newly appeared sound source other than the existing sound source can be accurately detected.

### Third Example Embodiment

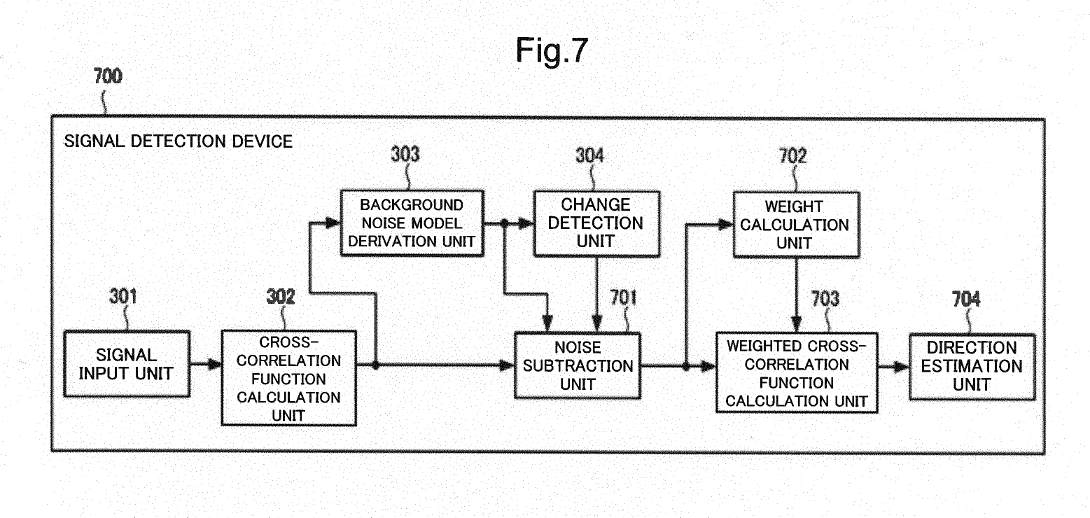

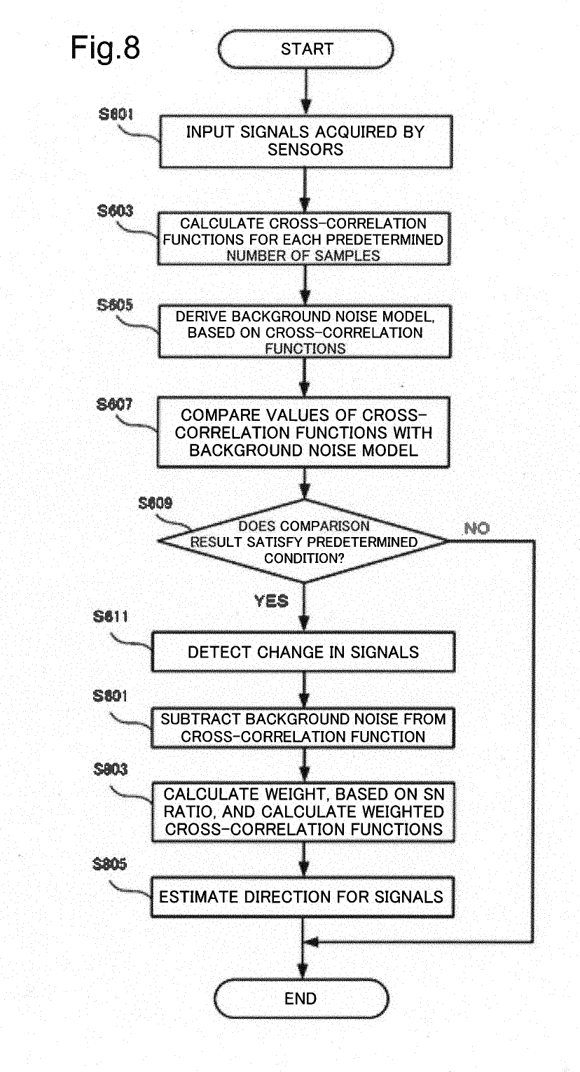

Next, a signal detection device 700 according to a third example embodiment of the present invention will be described referring to FIG. 7 and FIG. 8. FIG. 7 is a block diagram illustrating a functional configuration of the signal detection device 700 according to the present example embodiment. In comparison with the above-described second example embodiment, the signal detection device 700 according to the present example embodiment differs in that the signal detection device 700 includes a noise subtraction unit, a weight calculation unit, a weighted cross-correlation function calculation unit, and a direction estimation unit. Other configuration and operation is similar to that of the second example embodiment, and thus, concerning the same configuration and operation, the same reference signs are assigned, and the detailed description thereof is omitted.

The signal detection device 700 further includes a noise subtraction unit 701, a weight calculation unit 702, a weighted cross-correlation function calculation unit 703, and a direction estimation unit 704.

The noise subtraction unit 701 subtracts a background noise component from each of cross-correlation functions of 1 frames calculated by the cross-correlation function calculation unit 302, by using a background noise model derived by the background noise model derivation unit 303, when the change detection unit 304 detects a change (an acoustic event) in a sound field. For example, the change detection unit 304 calculates a cross-correlation function c_{f}(i,τₛ), (k−l+1≤i≤k) of the frame number i after the noise subtraction by equation (9).

[Equation 9]

c_{f}(i,τₛ)=0 (if |c(i,τₛ)−μ(τₛ)|<sσ_{b}(τₛ))

c_{f}(i,τₛ)=c(i,τₛ)−μ(τₛ) (otherwise) (9)

Herein, s is a real number that is zero or more. As s is larger, a component of the cross-correlation function deviating more from the background noise remains. When a direction of a small sound (a target sound) is to be estimated by the cross-correlation function, s needs to be small.

The weight calculation unit 702 calculates a weight w(i), (k−l+1≤i≤k). The weight w(i) is calculated in such a way as to become larger as a signal-to-noise ratio (an SN ratio) calculated based on the cross-correlation function for the evaluation-target frame is larger. Herein, the signal corresponds to a direct sound and the noise corresponds to a sound component other than the direct sound. The noise includes a reflected sound and an abrupt noise, for example.

For example, in a simple method, assuming that an SN ratio is unknown, w(i)=1 is set for all the frames. Alternatively, when an SN ratio is equal to or more than a threshold value set in advance, w(i)=1 may be set, and when an SN ratio is less than the threshold value, w(i)=0 may be set. Alternatively, a weight in proportion to an SN ratio may be calculated from equation (10).

[Equation 10]

w(i)=h×SN(i) (10)

Herein, h is a real number that is zero or more. For example, h may be determined in such a way as to satisfy equation (11).

$$\begin{matrix}[ Equation 11 ] & \\ {\sum }_{i = k - l + 1}^{k} w ( i ) = 1 & ( 11 )\end{matrix}$$

Herein, SN(i) represents an SN ratio, and is calculated by equation (12), for example.

$$\begin{matrix}[ Equation 12 ] & \\ SN ( i ) = \frac{{max}_{{τ}_{s}} {\{ \vert {c}_{f} ( i , {τ}_{s} ) \vert \}}^{2}}{{\sum }_{{τ}_{s}} {\vert {c}_{f} ( i , {τ}_{s} ) \vert}^{2}} & ( 12 )\end{matrix}$$

The weight may be calculated also by equation (13) that is a power of the equation (10).

[Equation 13]

w(i)={h×SN(i)}^{p} (13)

The weighted cross-correlation function calculation unit 703 calculates weighted cross-correlation functions that are each obtained by weighting cross-correlation functions calculated by the noise subtraction unit 701 with weights calculated by the weight calculation unit 702, based on equation (14).

$$\begin{matrix}[ Equation 14 ] & \\ {c}_{w} ( k , {τ}_{s} ) = {\sum }_{i = k - l + 1}^{k} w ( i ) {c}_{f} ( i , {τ}_{s} ) & ( 14 )\end{matrix}$$

The direction estimation unit 704 estimates a sound source direction θ, based on equation (15), by using the lag sample number τₛ=Γₛ at which a value of the weighted cross-correlation function c_{w}(k, τₛ) is the maximum, or equal to or more than a threshold value.

$$\begin{matrix}[ Equation 15 ] & \\ θ = arccos \frac{v {Γ}_{s}}{d} & ( 15 )\end{matrix}$$

Herein, d is a distance between two microphones, and ν is a sound speed.

FIG. 8 is a flowchart illustrating processing procedure of the signal detection device 700 according to the present example embodiment. The CPU 501 in FIG. 5 performs processes in the flowchart by using the RAM 503 to implement each functional constituent unit in FIG. 7. Note that the same step numbers are assigned to the steps similar to those in FIG. 6, and the description is omitted.

In step S801, the signal detection device 700 subtracts the background noise from each of the cross-correlation functions. In step S803, the signal detection device 700 calculates a weight, based on an SN ratio, and calculates each of weighted cross-correlation functions by multiplying the cross-correlation functions by the calculated weights respectively. In step S805, the signal detection device 700 estimates a direction for the signals, based on the weighted cross-correlation functions.

According to the present example embodiment, the weighted cross-correlation functions are calculated with weights. The weight is larger as an SN ratio is larger in the frame, namely, as a direct sound is larger compared with a reflected sound in the frame. Then, based on the calculated weighted cross-correlation functions, a sound source direction is estimated. Thus, influence of erroneous detection due to a reflected sound can be suppressed. Therefore, even in a reverberation environment such as inside of a room, a direction and a position of a sound source can be accurately estimated.

### Fourth Example Embodiment

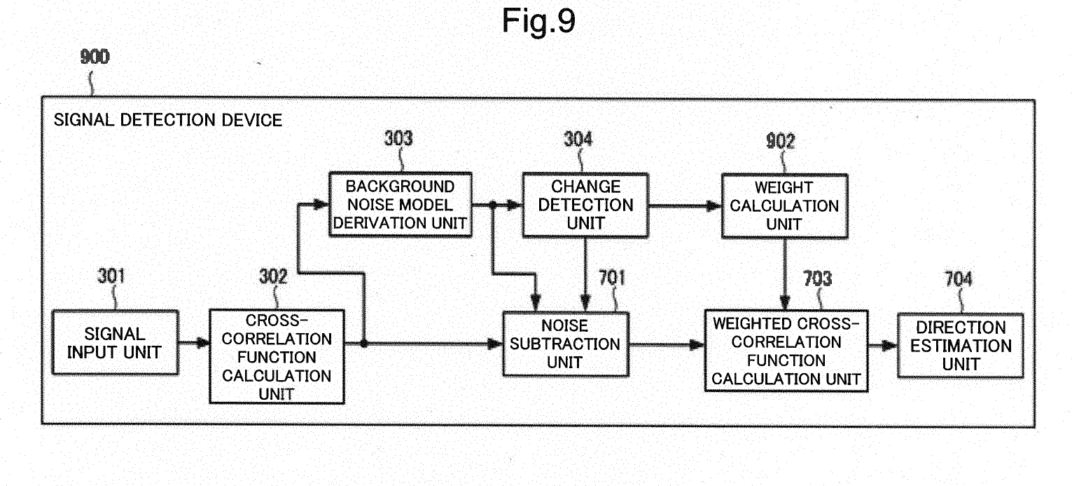

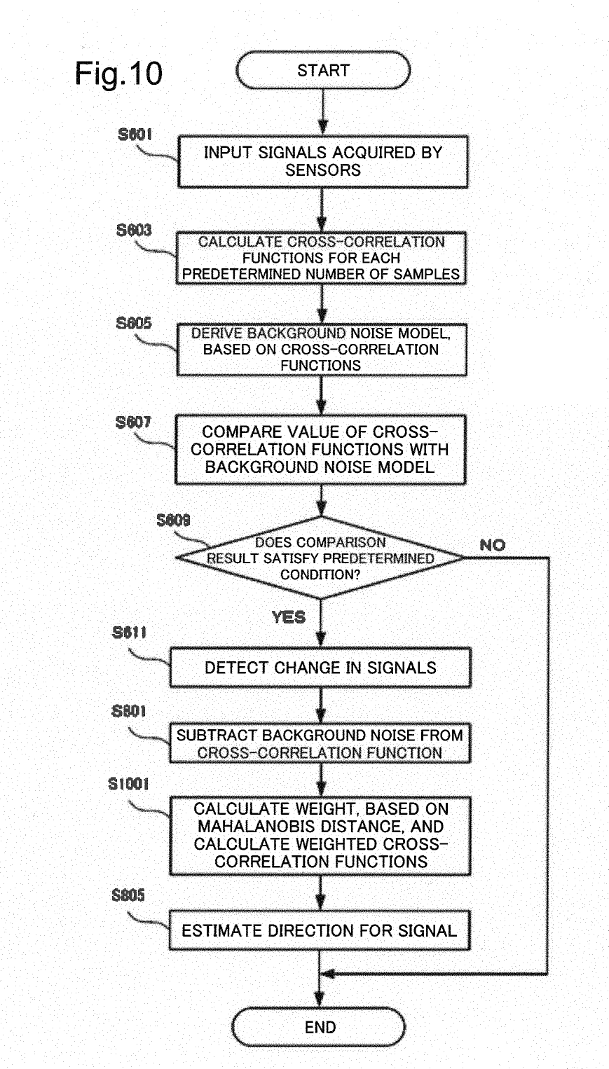

Next, a signal detection device 900 according to a fourth example embodiment of the present invention will be described referring to FIG. 9 and FIG. 10. FIG. 9 is a block diagram illustrating a functional configuration of the signal detection device 900 according to the present example embodiment. Compared with the above-described third example embodiment, the signal detection device 900 according to the present example embodiment differs in that the signal detection device 900 includes a weight calculation unit 902 instead of the weight calculation unit 702. Other configuration and operation is similar to that of the third example embodiment, and thus, concerning the same configuration and operation, the same reference signs are assigned, and the detailed description thereof is omitted.

The signal detection device 900 includes the weight calculation unit 902. The weight calculation unit 902 calculates a weight by equation (16), using a Mahalanobis distance MDᵢ calculated by the change detection unit 304.

[Equation 16]

w(i)={h×MDᵢ}^{p} (16)

Herein, p is a real number, and h is a real number that is zero or more.

FIG. 10 is a flowchart illustrating processing procedure of the signal detection device 900 according to the present example embodiment. The CPU 501 in FIG. 5 performs processes in the flowchart by using the RAM 503 to implement each functional constituent unit in FIG. 7. Note that the same step numbers are assigned to the steps similar to those in FIG. 6, and the description is omitted.

In step S1001, the signal detection device 900 calculates a weight, based on a Mahalanobis distance calculated by the change detection unit 304, and calculates weighted cross-correlation functions by multiplying the cross-correlation functions by the calculated weights respectively.

According to the present example embodiment, the weighted cross-correlation functions with weights each of which is larger as a Mahalanobis distance is larger in the frame are used. Therefore, a direction of a sound source can be estimated.

### Other Example Embodiments

While the present invention has been particularly shown and described with reference to the example embodiments thereof, the present invention is not limited to the embodiments. It will be understood by those of ordinary skill in the art that various changes in form and details may be made therein without departing from the spirit and scope of the present invention as defined by the claims. A system or a device that is made by combining, in any manner, respective characteristics included in the example embodiments is included in scope of the present invention.

Further, the present invention may be applied to a system configured by a plurality of devices, or may be applied to a single device. Furthermore, the present invention is applicable when an information processing program that implements the functions of the example embodiment is supplied to a system or a device directly or from a remote position. Accordingly, a program to be installed in a computer, a medium that stores the program, and a World Wide Web (WWW) server that allows the program to be downloaded, in order to implement the functions of the present invention in a computer are included in scope of the present invention, as well. Particularly, at least a non-transitory computer readable medium that recording thereon a program causing a computer to execute processing steps included in the above-described example embodiment is included in scope of the present invention.

### Other Expression of Example Embodiments

The whole or part of the example embodiments disclosed above can be described as, but not limited to, the following supplementary notes.

### (Supplementary Note 1)

A signal detection device including:

signal input means for inputting signals acquired by a plurality of sensors;

cross-correlation function calculation means for calculating cross-correlation functions for each predetermined number of samples, based on the signals;

background noise model derivation means for deriving a background noise model, based on the cross-correlation functions; and

detection means for detecting a change in the signals, based on comparison of values of the cross-correlation functions with the background noise model.

### (Supplementary Note 2)

The signal detection device according to the supplementary note 1, further including:

background noise subtraction means for calculating background noise subtracted cross-correlation functions by respectively subtracting background noises specified based on the background noise model from the cross-correlation functions, when the detection means detects the change in the signals;

weight calculation means for calculating a weight for each predetermined number of samples, based on a signal-to-noise ratio calculated from the background noise subtracted cross-correlation functions;

weighted cross-correlation function calculation means for calculating weighted cross-correlation functions by multiplying the background noise subtracted cross-correlation functions by the weight; and direction estimation means for estimating a direction for the signals, based on the weighted cross-correlation functions.

### (Supplementary Note 3)

The signal detection device according to the supplementary note 1, further including:

background noise subtraction means for calculating background noise subtracted cross-correlation functions by respectively subtracting background noise specified based on the background noise model from the cross-correlation functions, when the detection means detects the change in the signals;

weight calculation means for calculating a weight for each predetermined number of samples, based on a distance of the background noise subtracted cross-correlation functions from the background noise model;

weighted cross-correlation function calculation means for calculating weighted cross-correlation functions by multiplying the background noise subtracted cross-correlation functions by the weight; and

direction estimation means for estimating a direction for the signals, based on the weighted cross-correlation functions.

### (Supplementary Note 4)

The signal detection device according to the supplementary note 3, wherein

the distance is a Mahalanobis distance of the cross-correlation functions from the background noise model.

### (Supplementary Note 5)

The signal detection device according to the supplementary note 4, wherein

the detection means detects a change in the signals when the Mahalanobis distance exceeds a predetermined threshold during successive frames of a time period equal to or more than a predetermined value.

### (Supplementary Note 6)

The signal detection device according to any one of the supplementary notes 2 to 5, wherein,

when a change in the signals is detected, the direction estimation means estimates a direction for the signals, based on a lag sample number at which the weighted cross-correlation function is maximum.

### (Supplementary Note 7)

The signal detection device according to any one of the supplementary notes 2 to 5, wherein,

when a change in the signals is detected, the direction estimation means estimates a direction for the signal, based on a lag sample number at which the cross-correlation function is maximum.

### (Supplementary Note 8)

The signal detection device according to the supplementary note 2 or 6, wherein

the weight calculation means calculates the weight for each predetermined number of samples, based on the signal-to-noise ratio obtained by dividing a signal power by a signal noise power, the signal power being a square of a maximum value among the background noise subtracted cross-correlation functions, the signal noise power being a square sum of the background noise subtracted cross-correlation functions.

### (Supplementary Note 9)

The signal detection device according to the supplementary note 2 or 6, wherein

the weight calculation means sets the weight to one when the signal-to-noise ratio is equal to or more than a predetermined threshold value, and sets the weight to zero when the signal-to-noise ratio is less than the predetermined threshold value.

### (Supplementary Note 10)

The signal detection device according to any one of the supplementary notes 1 to 9, wherein

the background noise model derivation means calculates an average and a variance-covariance matrix, based on the background noise model.

### (Supplementary Note 11)

A signal detection method including:

a signal input step for inputting signals acquired by a plurality of sensors;

a cross-correlation function calculation step for calculating cross-correlation functions for each predetermined number of samples, based on the signals;

a background noise model derivation step for deriving a background noise model, based on the cross-correlation functions; and

a detection step for detecting a change in the signals, based on comparison of values of the cross-correlation functions with the background noise model.

### (Supplementary Note 12)

A computer readable storage medium recording thereon a signal detection program causing a computer to execute:

a signal input step for inputting signals acquired by a plurality of sensors;

a cross-correlation function calculation step for calculating cross-correlation functions for each predetermined number of samples, based on the signals;

a background noise model derivation step for deriving a background noise model, based on the cross-correlation functions; and

a detection step for detecting a change in the signals, based on comparison of values of the cross-correlation functions with the background noise model.

This application is based upon and claims the benefit of priority from Japanese patent application No. 2015-128481, filed on Jun. 26, 2015, the disclosure of which is incorporated herein in its entirety by reference.

What is claimed is:

1. A signal detection device comprising:
a signal input unit that inputs signals acquired by a plurality of sensors;
a cross-correlation function calculation unit that calculates cross-correlation functions for each predetermined number of samples, based on the signals;
a background noise model derivation unit that derives a background noise model, based on the cross-correlation functions; and
a detection unit that detects a change in the signals, based on comparison of values of the cross-correlation functions with the background noise model.

2. The signal detection device according to claim 1, further comprising:
a background noise subtraction unit that calculates background noise subtracted cross-correlation functions by respectively subtracting background noises specified based on the background noise model from the cross-correlation functions, when the detection means detects the change in the signals;
a weight calculation unit that calculates a weight for each predetermined number of samples, based on a signal-to-noise ratio calculated from the background noise subtracted cross-correlation functions;
a weighted cross-correlation function calculation unit that calculates weighted cross-correlation functions by multiplying the background noise subtracted cross-correlation functions by the weight; and
a detection estimation unit that estimates a direction for the signals, based on the weighted cross-correlation functions.

3. The signal detection device according to claim 1, further comprising:
a background noise subtraction unit that calculates background noise subtracted cross-correlation functions by respectively subtracting background noise specified based on the background noise model from the cross-correlation functions, when the detection means detects the change in the signals;
a weight calculation unit that calculates a weight for each predetermined number of samples, based on a distance of the background noise subtracted cross-correlation functions from the background noise model;
a weighted cross-correlation function calculation unit that calculates weighted cross-correlation functions by multiplying the background noise subtracted cross-correlation functions by the weight; and
a detection estimation unit that estimates a direction for the signals, based on the weighted cross-correlation functions.

4. The signal detection device according to claim 3, wherein
the distance is a Mahalanobis distance of the cross-correlation functions from the background noise model.

5. The signal detection device according to claim 4, wherein
the detection unit detects a change in the signals when the Mahalanobis distance exceeds a predetermined threshold during successive frames of a time period equal to or more than a predetermined value.

6. The signal detection device according to claim 2, wherein,
when a change in the signals is detected, the direction estimation unit estimates a direction for the signals, based on a lag sample number at which the weighted cross-correlation function is maximum.

7. The signal detection device according to claim 2, wherein
the weight calculation unit calculates the weight for each predetermined number of samples, based on the signal-to-noise ratio obtained by dividing a signal power by a signal noise power, the signal power being a square of a maximum value among the background noise subtracted cross-correlation functions, the signal noise power being a square sum of the background noise subtracted cross-correlation functions.

8. The signal detection device according to claim 1, wherein
the background noise model derivation unit calculates an average and a variance-covariance matrix, based on the background noise model.

9. A signal detection method comprising:
inputting signals acquired by a plurality of sensors;
calculating cross-correlation functions for each predetermined number of samples, based on the signals;
deriving a background noise model, based on the cross-correlation functions; and
detecting a change in the signals, based on comparison of values of the cross-correlation functions with the background noise model.

10. A non-transitory computer readable storage medium recording thereon a signal detection program causing a computer to execute a method comprising:
inputting signals acquired by a plurality of sensors;
calculating cross-correlation functions for each predetermined number of samples, based on the signals;
deriving a background noise model, based on the cross-correlation functions; and
detecting a change in the signals, based on comparison of values of the cross-correlation functions with the background noise model.

11. The signal detection device according to claim 2, wherein,
when a change in the signals is detected, the direction estimation unit estimates a direction for the signal, based on a lag sample number at which the cross-correlation function is maximum.

12. The signal detection device according to claim 2, wherein
the weight calculation unit sets the weight to one when the signal-to-noise ratio is equal to or more than a predetermined threshold value, and sets the weight to zero when the signal-to-noise ratio is less than the predetermined threshold value.
